(19) United States
(12) Patent Application Publication
(10) Pub. No.: US 2022/0292533 A1
(43) Pub. Date: Sep. 15, 2022

(54) DEMAND PREDICTION DEVICE

(71) Applicant: NTT DOCOMO, INC., Chiyoda-ku (JP)

(72) Inventors: Takumi OOSUGI, Chiyoda-ku (JP); Tsukasa DEMIZU, Chiyoda-ku (JP); Yusuke FUKAZAWA, Chiyoda-ku (JP); Mototsugu SUZUKI, Chiyoda-ku (JP)

(73) Assignee: NTT DOCOMO, INC., Chiyoda-ku (JP)

(21) Appl. No.: 17/638,117

(22) PCT Filed: Aug. 26, 2020
(86) PCT No.: PCT/JP2020/032179

§ 371 Date: Feb. 24, 2022

(30) Foreign Application Priority Data
Aug. 28, 2019 (JP) 2019-156075

(51) Int. Cl. G06Q 30/02; G06N 20/00

(52) U.S. Cl. CPC G06Q 30/0204; G06Q 30/0201; G06N 20/00

(57) ABSTRACT

A demand prediction device calculates time-series data of a prediction value of future demand for durable goods belonging to a particular broad division through time-series analysis, constructs a model for calculating a purchase probability based on attribute information, information on types of durable goods purchased by the users, and time information on the purchase, calculates purchase probability data including a purchase probability of the durable goods in each of time periods for each of users and a purchase probability for the broad division and each of the plurality of subdivisions of durable goods for each of the users by inputting the attribute information of the users to the model, and calculates and outputs a prediction value of the total demand for each of the plurality of subdivisions in a particular time period based on the time-series data of the prediction value and the purchase probability data.

### TECHNICAL FIELD

An aspect of the present invention relates to a demand prediction device that predicts the demand for durable goods.

### BACKGROUND ART

In the related art, devices that predict the demand for goods are known (see Patent Literatures 1 to 3). For example, the device described in Patent Literature 1 calculates a sales prediction model of goods from past sales results data of the goods and predicts sales or trends of prediction target goods based on an estimated sales trend phase, customer types, and the sale prediction model. The device described in Patent Literature 2 trains a prediction model based on an elapsed time from a start of sale of goods, words included in goods names, and a demand volume of the goods after the start of sale. The device described in Patent Literature 3 calculates a prediction value of the demand at an arbitrary time point by performing a regression analysis process on time-series data indicating temporal change of the number of purchased goods.

### CITATION LIST

### Patent Literature

[Patent Literature 1] Japanese Unexamined Patent Publication No. H10-307808
[Patent Literature 2] PCT International Publication No. WO 2017/163278
[Patent Literature 3] Japanese Unexamined Patent Publication No. 2008-305229

### SUMMARY OF INVENTION

### Technical Problem

However, in the techniques described in Patent Literatures 1 to 3, regarding durable goods which are in a plurality of large and small divisions and which are relatively frequently traded in the market due to performance upgrade of products, selection preferences of divisions for each of users may not be reflected in predicted values of temporal change in demand for goods. Accordingly, it may be difficult to predict change in demand for each of divisions in consideration of the selection preferences of the users.

Therefore, in order to solve the aforementioned problems, an objective of the present invention is to provide a demand prediction device that can predict a change in demand for each of divisions of durable goods in consideration of selection preferences of each of users.

### Solution to Problem

A demand prediction device according to the present embodiment is a demand prediction device that predicts the demand for durable goods, the demand prediction device including at least one processor. The at least one processor is configured to calculate time-series data of a prediction value of future demand for durable goods belonging to a particular broad division through time-series analysis based on time-series data of past demand for the durable goods belonging to the particular broad division, to construct a model of machine learning for calculating a purchase probability of the durable goods in each of time periods for each of users and a purchase probability for the broad division and each of a plurality of subdivisions of the durable goods for each of users based on attribute information of users, information on types of durable goods purchased in the past by the users, and time information on the purchase, to calculate purchase probability data including a purchase probability of the durable goods in each of time periods in the future for each of users and a purchase probability for the broad division and each of the plurality of subdivisions of durable goods of each of users by inputting at least the attribute information of the users to the model, and to calculate and output a prediction value of the total demand for each of the plurality of subdivisions of the durable goods in a particular time period in the future based on the time-series data of the prediction value and the purchase probability data.

According to the embodiment, time-series data of the prediction value of the demand for durable goods belonging to a broad division is calculated, and purchase probability data including the purchase probability of the durable goods in each of time periods for each of users and the purchase probability for the broad division and each of the plurality of subdivisions of each of users is calculated by inputting the attribute information of the users to the model of machine learning which has been constructed in advance. The prediction value of the total demand for each of the plurality of subdivisions of the durable goods in the future is calculated based on the time-series data of the prediction value and the purchase probability data. In this way, since the time-based purchase probability for each of users and the purchase probability for each of divisions for each of users are reflected in the prediction value of the demand for the durable goods for all users, it is possible to accurately predict a detailed change in demand for durable goods for each of subdivisions in consideration of selection preferences of each of users.

### Advantageous Effects of Invention

According to an aspect of the present invention, it is possible to predict a change in demand for each of divisions of durable goods in consideration of selection preferences of each of users.

### BRIEF DESCRIPTION OF DRAWINGS

FIG. 1 is a block diagram illustrating a functional configuration of a demand prediction device 100 according to the present embodiment.

FIG. 2 is a diagram illustrating an example of a configuration of customer data including purchase result data stored in a customer data management device 200.

FIG. 3 is a graph illustrating time-series data for each month in the future calculated by a time-series analysis unit 101.

FIG. 4 is a diagram illustrating a function of a model constructed by a model generating unit 102.

FIG. 5 is a diagram illustrating a data configuration of a monthly purchase probability of durable goods in the future calculated by a purchase probability calculating unit 104.

FIG. 6 is a diagram illustrating a data configuration of a selection probability of durable goods for each of subdivisions calculated by the purchase probability calculating unit 104.

FIG. 7 is a diagram illustrating a configuration of time-series data calculated and output by a prediction value calculating unit 105.

FIG. 8 is a flowchart illustrating a model constructing process performed by the demand prediction device 100.

FIG. 9 is a flowchart illustrating a prediction value calculating process performed by the demand prediction device 100.

FIG. 10 is a diagram illustrating an example of an output screen output to a display of the demand prediction device 100 by the prediction value calculating unit 105.

FIG. 11 is a diagram illustrating an example of a hardware configuration of the demand prediction device 100 according to an embodiment of the present disclosure.

### DESCRIPTION OF EMBODIMENTS

Hereinafter, an embodiment of the present invention will be described with reference to the accompanying drawings. As far as possible, the same elements will be referred to by the same reference signs and repeated description thereof will be omitted.

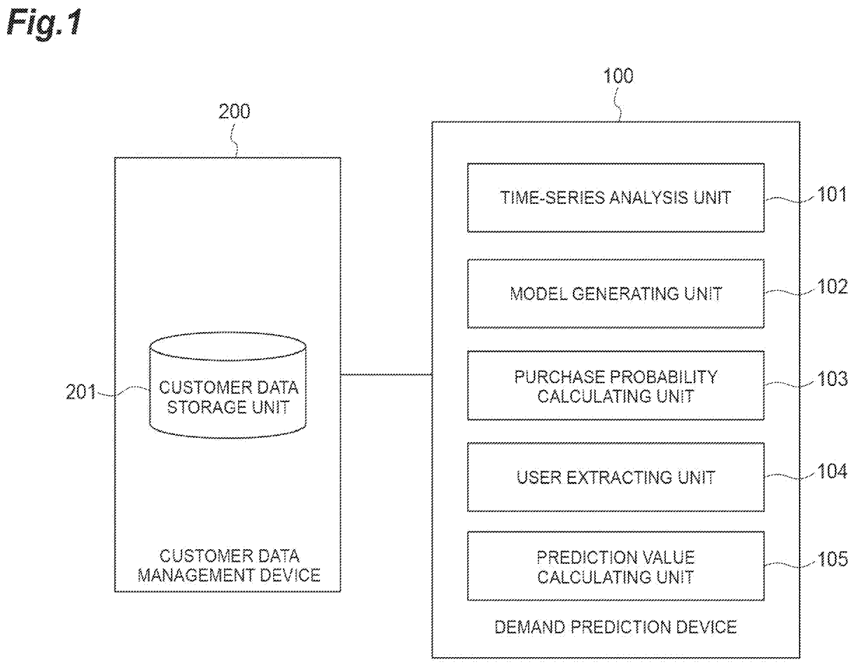

FIG. 1 is a block diagram illustrating a functional configuration of a demand prediction device 100 according to the present embodiment. As illustrated in FIG. 1, the demand prediction device 100 includes a time-series analysis unit 101, a model generating unit 102, a purchase probability calculating unit 103, a user extracting unit 104, and a prediction value calculating unit 105. The demand prediction device 100 is connected to a customer data management device 200 via a communication network such as a local area network (LAN) or a wide area network (WAN) which is not illustrated in a data communication-possible manner and is configured to be able to read data from the customer data management device 200. The customer data management device 200 is a database server including a customer data storage unit 201 and stores attribute data of users who have subscribed to a specific service or purchase result data of the user for consumer goods associated with the service in the customer data storage unit 201.

The time-series analysis unit 101 reads the purchase result data from the customer data management device 200 and calculates time-series data of a prediction value of the demand for durable goods belonging to a particular broad division in the future by time-series analysis. An example of the durable goods in the particular broad division to be predicted is an information processing device in which a specific operating system (OS) is mounted but is not limited thereto, and the durable goods may be another specific type of electronic devices or the like.

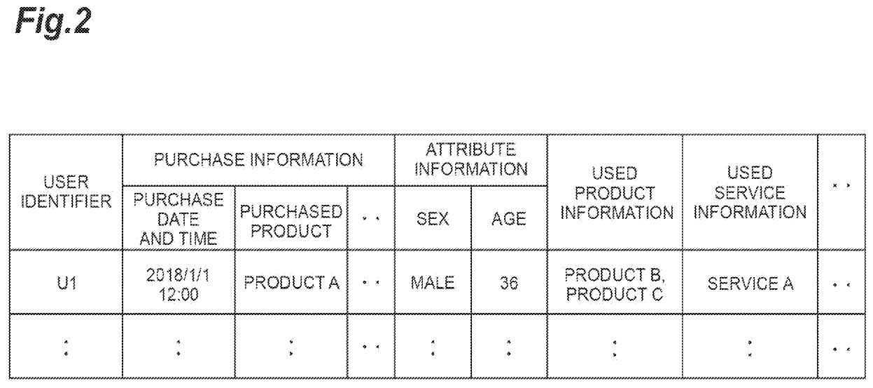

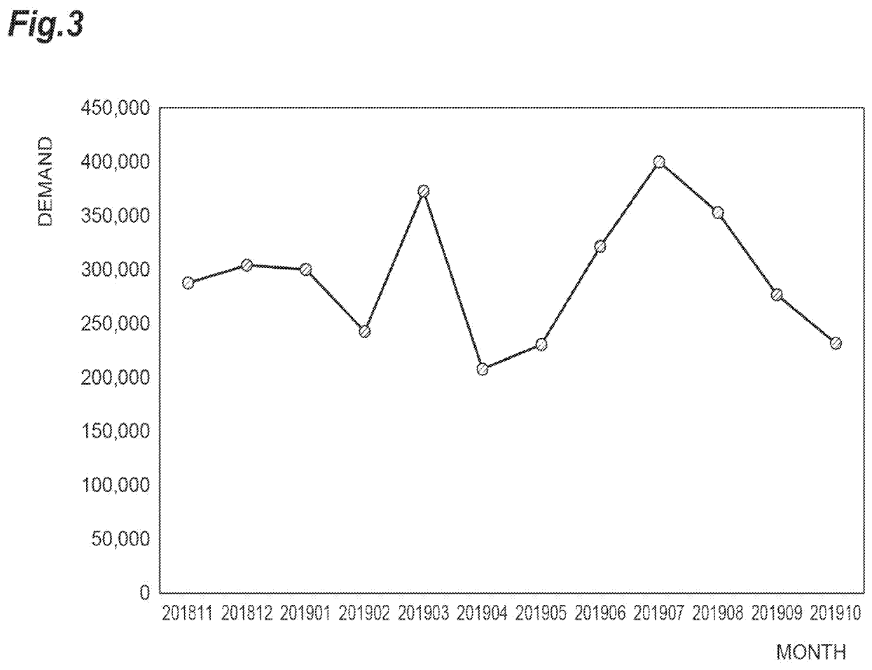

FIG. 2 illustrates an example of a configuration of customer data including purchase result data stored in the customer data management device 200. As illustrated in the drawing, it is conceivable that customer data include purchase information indicating types of products purchased in the past by a user and purchase date and times, attribute information indicating attributes such as sex and age of the user, used product information indicating products used in the past by the user, and other information of the user such as used service information indicating services used in the past by the user, in correlation with an identifier for identifying the user. By collecting the purchase information of the customer data, the time-series analysis unit 101 collects the demand for durable goods belonging to the broad division for each month in the past. The time-series analysis unit 101 calculates time-series data of a future monthly prediction value of the durable goods belonging to the broad division by performing time-series analysis using the collected data of the demand for each month in the past. For example, an autoregressive model (AR model), a moving average model (MA model), an ARMA model in which these models are combined, or a state space model may be used for the time-series analysis. FIG. 3 illustrates a graph of future monthly time-series data calculated by the time-series analysis unit 101. In this way, a change of the total demand in the future is predicted from the short-term and long-term trends of the total demand in the past.

Referring back to FIG. 1, the model generating unit 102 constructs a model of machine learning for calculating purchase probability data which will be described later based on the customer data stored in the customer data management device 200. Examples of an algorithm employed by the model of machine learning include a logistic regression algorithm, a k-nearest neighbor algorithm, a support vector machine, a random forest algorithm, a gradient boosting algorithm, and a deep neural network. That is, by using the attribute information, the used product information, the used service information, and the like included in the customer data for each of users as feature values (input data) and using data on the types of purchased products included in the purchase information included in the customer data for each of users as training data, the model generating unit 102 constructs a model “prediction model A” for calculating a selection probability (purchase probability) with which the corresponding user selects the durable goods belonging to the broad division at the time of purchase from the feature values of the user.

The model generating unit 102 constructs a model for calculating a selection probability of a user for each of a plurality of subdivisions including a plurality of hierarchies from feature values of the user using the same data as the feature values and training data. For example, the model generating unit 102 constructs a model “prediction model B” for calculating a selection probability for each of two divisions of an upper hierarchy (“upper hierarchy division 1” and “upper hierarchy division 2”), a model “prediction model C” for calculating a selection probability for each of three lower hierarchies (“lower hierarchy division 1,” “lower hierarchy division 2,” and “lower hierarchy division 3”) belonging to the upper hierarchy “upper hierarchy division 1,” and a model “prediction model D” for calculating a selection probability for each of three lower hierarchies (“lower hierarchy division 4,” “lower hierarchy division 5,” and “lower hierarchy division 6”) belonging to the upper hierarchy “upper hierarchy division 2.” Here, the number of hierarchies and the number of divisions of subdivisions for which a model needs to be constructed is an arbitrary number, and the model generating unit 102 constructs models corresponding to the number of branches of the subdivisions.

The model generating unit 102 constructs a model “monthly purchase prediction model” for calculating a purchase probability of each of users for each of time periods (months) of durable goods from feature values of the user using the same data as the feature values and data on a purchase time period included in the purchase information included in the customer data for the user as training data.

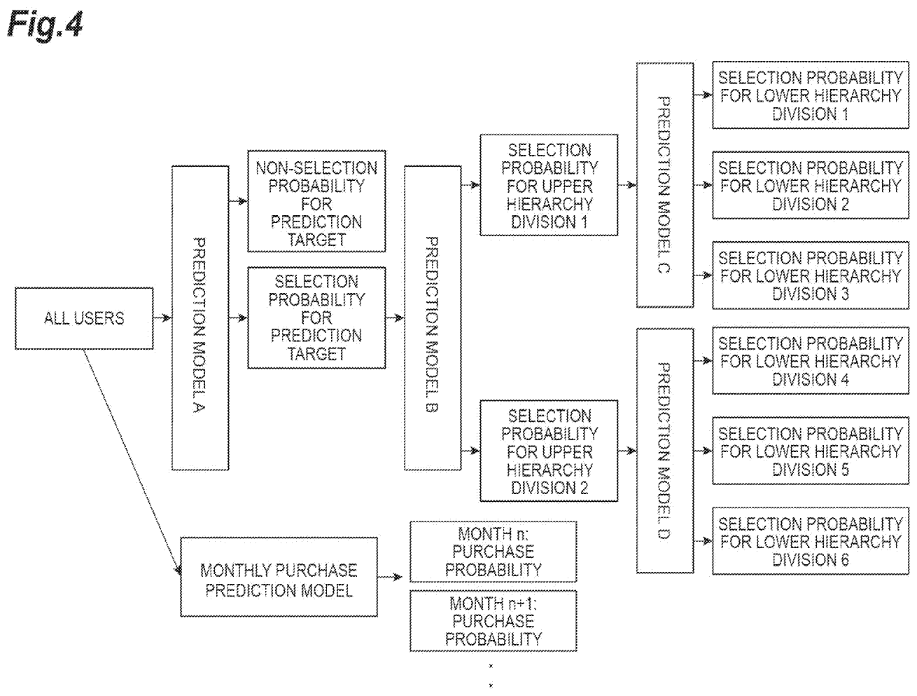

FIG. 4 is a diagram illustrating a function of a model constructed by the model generating unit 102. As illustrated in the drawing, a monthly purchase probability of durable goods in the future can be calculated by applying the “monthly purchase prediction model” for all users. A selection probability of durable goods in a broad division to be predicted can be calculated by applying a “prediction model A” for all users. A selection probability of durable goods which are hierarchically divided can be calculated for each of subdivisions of a hierarchical structure by applying “prediction model B,” “prediction model C,” and “prediction model D” for all users. In this case, it is possible to identify a division with a higher selection probability according to preferences of each of users at the time of actual purchase by calculating the selection probability for each of subdivisions of a hierarchical structure.

Referring back to FIG. 1, the purchase probability calculating unit 103 calculates purchase probability data including a monthly purchase probability of the durable goods in the future and a selection probability for a broad division and a plurality of subdivisions of the durable goods for each of all the users by inputting feature values to the model constructed by the model generating unit 102 using attribute information, used product information, used service information, and the like included in the customer data of all the users as the feature values.

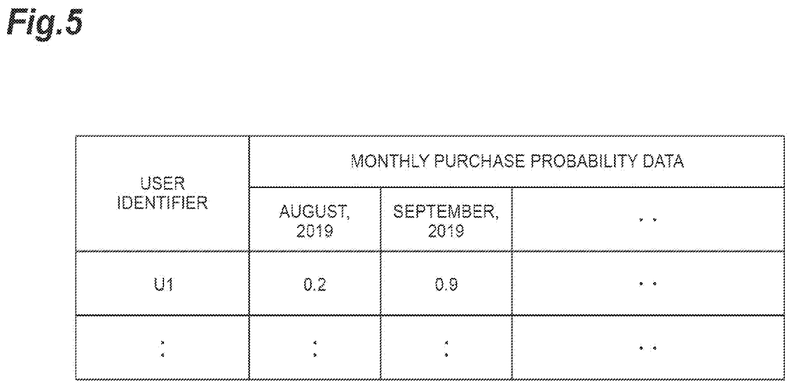

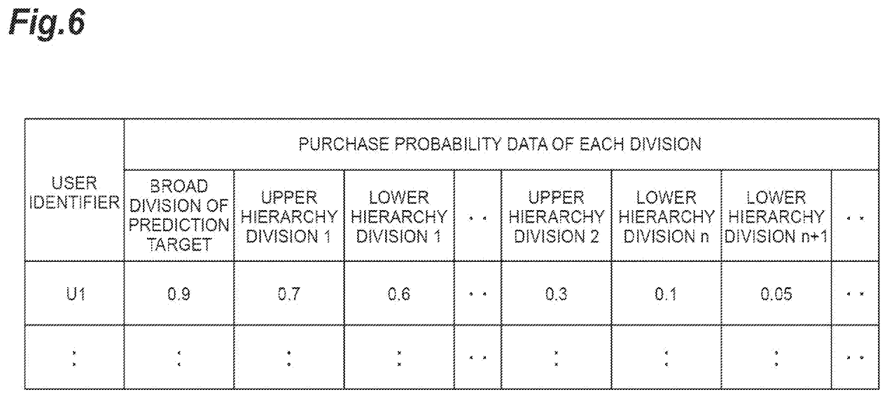

FIG. 5 illustrates a data configuration of a monthly purchase probability of durable goods in the future calculated by the purchase probability calculating unit 103. FIG. 6 illustrates a data configuration of a selection probability of durable goods for each of subdivisions calculated by the purchase probability calculating unit 103. As illustrated in the drawings, data indicating the calculated monthly purchase probability in the future, the calculated selection probability of a broad division, and the calculated selection probability of each of subdivisions having a hierarchical structure is stored in correlation with an identifier for identifying each of users.

Referring back to FIG. 1, the user extracting unit 104 extracts a prediction value of the total demand for durable goods in the broad division in a particular time period (month) in the future from the time-series data calculated by the time-series analysis unit 101. Then, the user extracting unit 104 extracts a plurality of users corresponding to the extracted prediction value of the demand based on the purchase probability data calculated by the purchase probability calculating unit 103. Specifically, the user extracting unit 104 extracts users corresponding to the prediction value of the demand in the order in which a selection probability for selecting the durable goods in the broad division to be predicted decreases out of users of which the purchase probability in the particular month is higher than a preset threshold value with reference to the purchase probability data. The user extracting unit 104 repeatedly performs such extraction of users for each month included in a prediction target period.

The prediction value calculating unit 105 calculates and outputs the prediction value of the demand for all users for each of a plurality of subdivisions as time-series data by performing processing on the users extracted for each month included in the prediction target period by the user extracting unit 104. Specifically, the prediction value calculating unit 105 repeatedly selects a subdivision with a highest selection probability for each of a plurality of hierarchies with reference to the selection probabilities of the subdivisions of the plurality of hierarchies from the upper hierarchy, and identifies a finally selected lowest subdivision for all the extracted users. Then, the prediction value calculating unit 105 calculates the prediction value of the total demand for each of the plurality of subdivisions by totaling the number of users identified for each of subdivisions of the lowest hierarchy. At this time, the prediction value calculating unit 105 may use the total number of users as the prediction value without any change or may use a value obtained by converting the total value according to the total number of users who can purchase the durable goods as the prediction value. The prediction value calculating unit 105 calculates time-series data of the prediction value by repeatedly calculating the prediction value of the demand for each of subdivisions for each month included in the prediction target period.

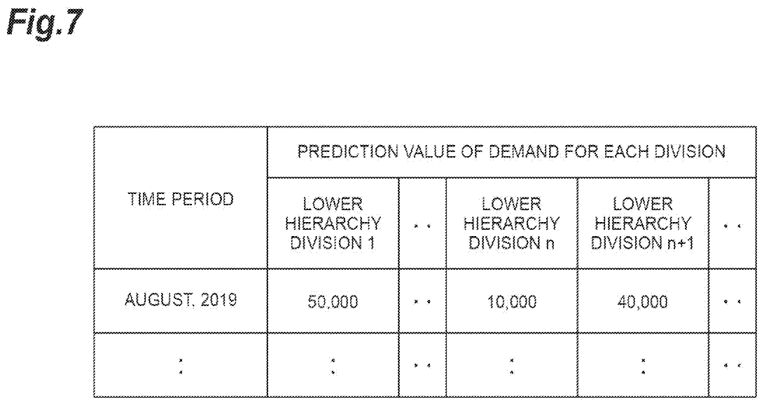

FIG. 7 illustrates an example of a configuration of time-series data calculated and output by the prediction value calculating unit 105. In this way, the prediction value of the demand for each of the lowest subdivisions “lower hierarchy division 1,” . . . , “lower hierarchy division n,” “lower hierarchy division n+1,” . . . for each of time periods included in the prediction target period is included in the time-series data. The time-series data may be passively or actively transmitted to an external device such as a terminal device of a user who is a user of the demand prediction device 100 via a communication network, may be output to an output device such as a display in the demand prediction device 100, or may be stored in an internal memory or the like of the demand prediction device 100.

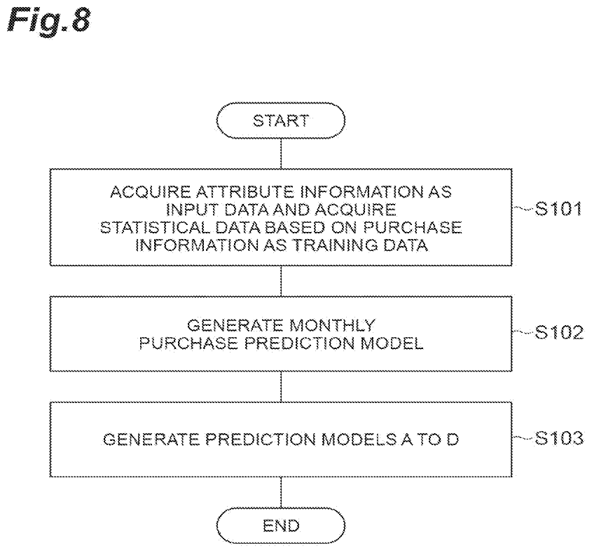

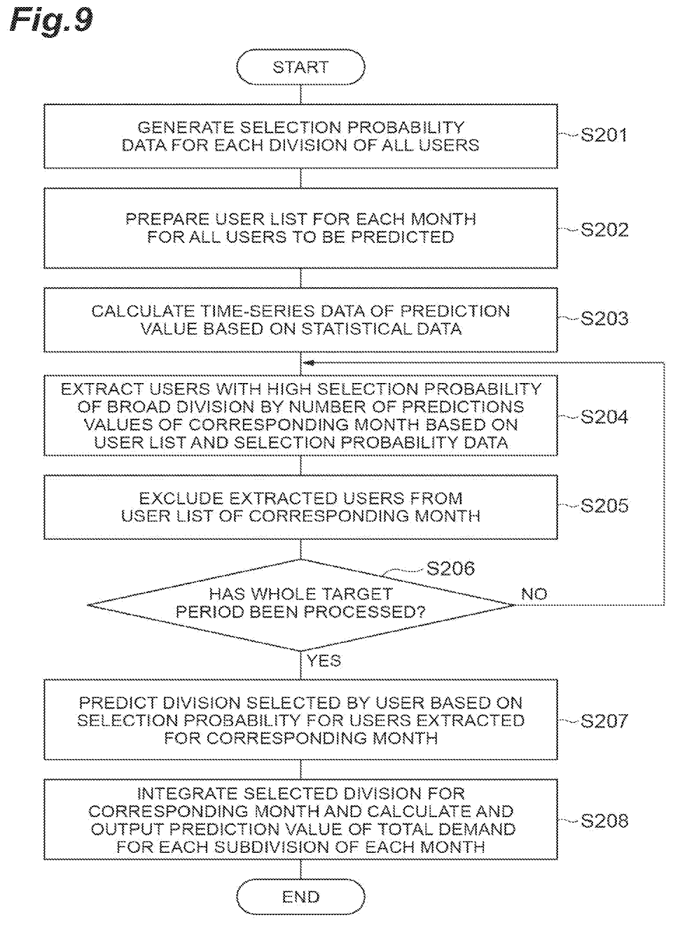

A process routine which is performed by the demand prediction device 100 having the aforementioned configuration will be described below. FIG. 8 is a flowchart illustrating a model constructing process which is performed by the demand prediction device 100. FIG. 9 is a flowchart illustrating a prediction value calculating process which is performed by the demand prediction device 100. The model constructing process is performed in advance at an arbitrary timing before the prediction value calculating process is performed.

As illustrated in FIG. 8, the model generating unit 102 acquires purchase information of users which is used as training data as statistical data corresponding to a predetermined number of users from the customer data management device 200 and acquires feature values (input data) such as attribute information of the users corresponding to the purchase information (Step S101). Then, the model generating unit 102 generates a model “monthly purchase prediction model” for calculating monthly purchase probabilities of the users for durable goods using the acquired training data and the acquired feature values (Step S102). The model generating unit 102 generates models “prediction model A,” “prediction model B,” “prediction model C,” and “prediction model D” for calculating selection probabilities of the users for a broad division and each of a plurality of subdivisions including a plurality of hierarchies based on the training data and the feature values (Step S103).

A routine of the prediction value calculating process will be described below with reference to FIG. 9. First, the purchase probability calculating unit 103 calculates purchase probability data indicating purchase probabilities for each month in the future and selection probabilities for the broad division and the subdivisions by applying the model generated in the model constructing process to all the users with reference to customer data stored in the customer data management device 200 (Step S201). Then, the purchase probability calculating unit 103 prepares a user list for each target month included in the prediction target period based on identification information corresponding to all the users to be predicted which is stored in the customer data (Step S202).

Thereafter, the time-series analysis unit 101 generates statistical data of the demand for each month in the past by collecting purchase information included in the customer data and calculates time-series data of the prediction values of the demand for each month in the future by performing time-series analysis on the statistical data (Step S203). Then, the user extracting unit 104 extracts users corresponding to the prediction values of the demand in the order in which the selection probability of the broad division to be predicted decreases out of users whose the purchase probability is higher than a threshold value for each month of the prediction target period based on the user list and the selection probability data (Step S204). Then, the user extracting unit 104 excludes the extracted users from the user list of the corresponding month (Step S205). The user extracting unit 104 determines whether extraction of users has been completed for all the months included in the prediction target period (Step S206), and returns the routine to Step S204 when the extraction has not been completed (Step S206: NO).

On the other hand, when the extraction of users has been completed (Step S206: YES), the prediction value calculating unit 105 identifies subdivisions of the lowest hierarchy corresponding to the number of the extracted users and calculates the prediction values of the demand for each of subdivisions of the lowest hierarchy by repeatedly selecting a subdivision with the highest selection probability out of the subdivisions in each of a plurality of hierarchies for each month included in the prediction target period (Step S207). Finally, the prediction value calculating unit 105 calculates and outputs time-series data of the prediction values by repeatedly calculating the prediction values of the demand for each of subdivisions of the lowest hierarchy for all the months included in the prediction target period (Step S208).

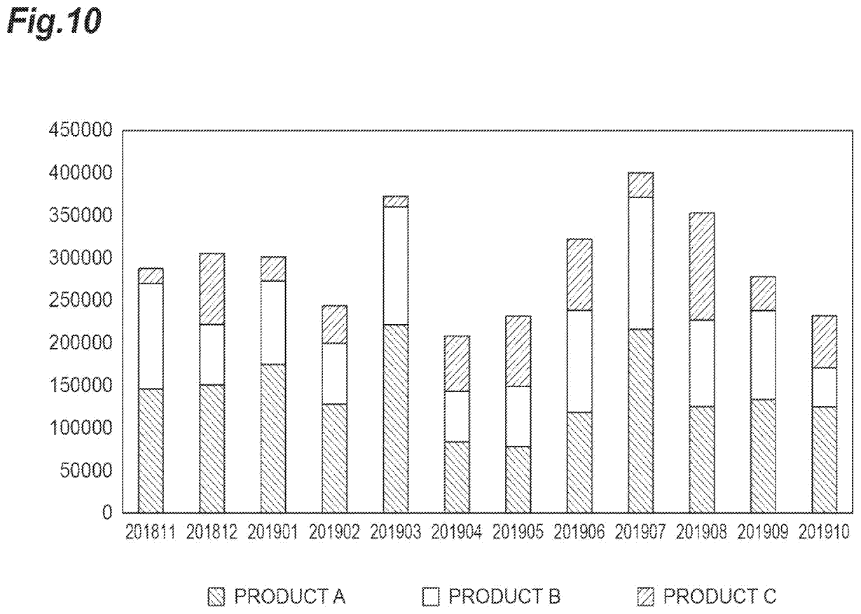

FIG. 10 illustrates an example of an output screen which is output to a display of the demand prediction device 100 by the prediction value calculating unit 105. As illustrated in the drawing, the prediction values of the demand for “product A,” “product B,” and “product C” indicating subdivisions for each month included in the prediction target period are displayed as a graph.

Operations and advantages of the demand prediction device 100 according to this embodiment will be described below. With the demand prediction device 100, time-series data of a prediction value of the demand for durable goods belonging to a broad division is calculated, and purchase probability data including a purchase probability of the durable goods in each of time periods for each of users and a purchase probability for the broad division and each of the plurality of subdivisions of each of users is calculated by inputting the attribute information of the users to the model of machine learning which has been constructed in advance. The prediction value of the total demand for each of the plurality of subdivisions of the durable goods in the future is calculated based on the time-series data of the prediction value and the purchase probability data. In this way, since the time-based purchase probability for each of users and the purchase probability for each of divisions for each of users are reflected in the prediction value of the demand for the durable goods for all users, it is possible to accurately predict a detailed change in demand for the durable goods for each of subdivisions in consideration of selection preferences of each of users.

When a prediction value of the total demand is calculated, the demand prediction device 100 calculates a prediction value of the total demand for each of a plurality of subdivisions by extracting a prediction value of the demand for durable goods in a particular time period from time-series data of prediction values, then extracting a plurality of users corresponding to the number of prediction values of the demand based on a purchase probability of durable goods in the particular time period based on the purchase probability data of the users, and totaling the demand for each of subdivisions based on the purchase probabilities for a broad division and a plurality subdivisions corresponding to the extracted users. With this configuration, by totaling the demand for each of subdivisions based on the purchase probabilities for each of divisions of the plurality of users after extracting the plurality of users corresponding to the prediction values of the demand for durable goods belonging to the broad division, it is possible to predict a change in demand for each of subdivisions in which selection preferences of each of users are finely reflected.

In this embodiment, the demand prediction device 100 calculates data of purchase probabilities of a plurality of subdivisions of a plurality of hierarchies using a model, and repeatedly selects a subdivision with the highest purchase probability for the plurality of hierarchies for each of the extracted users when a prediction value of the total demand is calculated. With this configuration, by repeatedly selecting a hierarchical subdivision with a high purchase probability for each of the extracted users, it is possible to predict a change in demand for each of subdivisions in which selection preferences of each of users at the time of actual purchasing are finely reflected.

The demand prediction device 100 extracts users with relatively high purchase probabilities of a broad division based on the purchase probabilities of durable goods when a plurality of users are extracted. With this configuration, by reflecting a preference of a user with an actually high purchase probability of durable goods of the broad division in the prediction result, it is possible to more accurately predict a change in demand for each of subdivisions.

The demand prediction device 100 calculates and outputs data of time-series prediction values by repeatedly predicting the total demand for a plurality of subdivisions of durable goods in a particular time period in the future. With this function, it is possible to predict a change in demand for each of subdivisions in a time series.

The block diagrams used to describe the aforementioned embodiment show blocks of functional units. These functional blocks (constituent units) are realized by an arbitrary combination of at least one of hardware and software. The realization method of each functional block is not particularly limited. That is, each functional block may be realized by a single device which is physically or logically coupled, or may be realized by two or more devices which are physically or logically separated and which are directly or indirectly connected (for example, in a wired or wireless manner). Each functional block may be realized by combining software in the single device or the two or more devices.

The functions include determining, deciding, judging, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (constituent units) for transmitting is referred to as a transmitting unit or a transmitter. As described above, the realizing method of each function is not particularly limited.

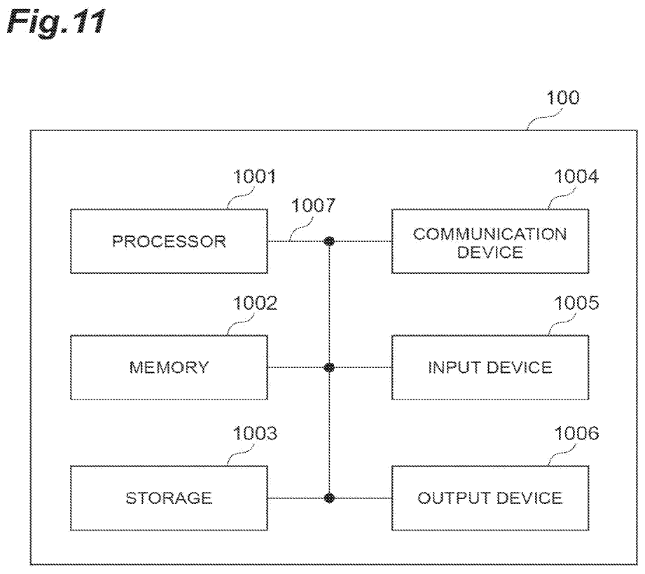

For example, the demand prediction device 100 according to an embodiment of the present disclosure may serve as a computer that performs the process steps of the demand prediction method according to the present disclosure. FIG. 11 is a diagram illustrating an example of a hardware configuration of the demand prediction device 100 according to an embodiment of the present disclosure. The demand prediction device 100 may be physically configured as a computer device including a processor 1001, a memory 1002, a storage 1003, a communication device 1004, an input device 1005, an output device 1006, and a bus 1007.

In the following description, the term “device” can be replaced with circuit, device, unit, or the like. The hardware configuration of the demand prediction device 100 may be configured to include one or more devices illustrated in the drawing or may be configured to exclude some devices thereof.

The functions of the demand prediction device 100 can be realized by reading predetermined software (program) to hardware such as the processor 1001 and the memory 1002 and causing the processor 1001 to execute arithmetic operations and to control communication using the communication device 1004 or to control at least one of reading and writing of data with respect to the memory 1002 and the storage 1003.

The processor 1001 controls a computer as a whole, for example, by causing an operating system to operate. The processor 1001 may be configured as a central processing unit (CPU) including an interface with peripherals, a controller, an arithmetic operation unit, and a register. For example, the time-series analysis unit 101, the model generating unit 102, the purchase probability calculating unit 103, the user extracting unit 104, and the prediction value calculating unit 105 may be realized by the processor 1001.

The processor 1001 reads a program (a program code), a software module, data, or the like from at least one of the storage 1003 and the communication device 1004 to the memory 1002 and performs various processes in accordance therewith. As the program, a program that causes a computer to perform at least some of the operations described in the above-mentioned embodiment is used. For example, the time-series analysis unit 101, the model generating unit 102, the purchase probability calculating unit 103, the user extracting unit 104, and the prediction value calculating unit 105 may be realized by a control program which is stored in the memory 1002 and which operates in the processor 1001, and the other functional blocks may be realized in the same way. The various processes described above are described as being performed by a single processor 1001, but they may be simultaneously or sequentially performed by two or more processors 1001. The processor 1001 may be mounted as one or more chips. The program may be transmitted from a network via an electrical communication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store a program (a program code), a software module, and the like that can be executed to perform a demand prediction method according to an embodiment of the present disclosure.

The storage 1003 is a computer-readable storage medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage media may be, for example, a database, a server, or another appropriate medium including at least one of the memory 1002 and the storage 1003.

The communication device 1004 is hardware (a transmitting and receiving device) that performs communication between computers via at least one of a wired network and a wireless network and is also referred to as, for example, a network device, a network controller, a network card, or a communication module. The communication device 1004 may include a radio-frequency switch, a duplexer, a filter, and a frequency synthesizer to realize, for example, at least one of frequency division duplex (FDD) and time division duplex (TDD). For example, an acquisition unit (not illustrated) or the like for acquiring the purchase result data may be realized by the communication device 1004. The acquisition unit may be physically or logically separated and mounted as a transmitting unit and a receiving unit.

The input device 1005 is an input device that receives an input from the outside (for example, a keyboard, a mouse, a microphone, a switch, a button, or a sensor). The output device 1006 is an output device that performs an output to the outside (for example, a display, a speaker, or an LED lamp). The input device 1005 and the output device 1006 may be configured as a unified body (for example, a touch panel).

The devices such as the processor 1001 and the memory 1002 are connected to each other via the bus 1007 for transmission of information. The bus 1007 may be constituted by a single bus or may be constituted by buses which are different depending on the devices.

The demand prediction device 100 may be configured to include hardware such as a microprocessor, a digital signal processor (DSP), an application-specific integrated circuit (ASIC), a programmable logic device (PLD), or a field-programmable gate array (FPGA), and some or all of the functional blocks may be realized by the hardware. For example, the processor 1001 may be mounted as at least one piece of hardware.

Notifying of information is not limited to the aspects/embodiments described in the present disclosure, but may be performed using another method. For example, notifying of information may be performed using physical layer signaling (for example, downlink control information (DCI), uplink control information (UCI)), upper layer signaling (for example, radio resource control (RRC) signaling, medium access control (MAC) signaling, notification information (master information block (MIB), or system information block (SIB))), other signaling, or a combination thereof. RRC signaling may be referred to as an RRC message and may be, for example, an RRC connection setup message or an RRC connection reconfiguration message.

The aspects/embodiments described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-Wide Band), Bluetooth (registered trademark), or another appropriate system and a next-generation system which is extended based thereon. A plurality of systems may be combined (for example, at least one of LTE and LTE-A and 5G may be combined) as an application.

The order of the processing steps, the sequences, the flowcharts, and the like of the aspects/embodiments described above in the present disclosure may be changed unless conflictions arise. For example, in the methods described in the present disclosure, various steps are described as elements of the exemplary order, but the methods are not limited to the described order.

Information or the like can be output from an upper layer (or a lower layer) to a lower layer (or an upper layer). Information or the like may be input and output via a plurality of network nodes.

Information or the like which is input or output may be stored in a specific place (for example, a memory) or may be managed using a management table. Information or the like which is input or output may be overwritten, updated, or added. Information or the like which is output may be deleted. Information or the like which is input may be transmitted to another device.

Determination may be performed using a value (0 or 1) which is expressed in one bit, may be performed using a Boolean value (true or false), or may be performed by comparison of numerical values (for example, comparison with a predetermined value).

The aspects/embodiments described in the present disclosure may be used alone, may be used in combination, or may be switched during implementation thereof. Notifying of predetermined information (for example, notifying that “it is X”) is not limited to explicit notification, and may be performed by implicit notification (for example, notifying of the predetermined information is not performed).

While the present disclosure has been described above in detail, it will be apparent to those skilled in the art that the present disclosure is not limited to the embodiments described in the present disclosure. The present disclosure can be altered and modified in various forms without departing from the gist and scope of the present disclosure defined by description in the appended claims. Accordingly, the description in the present disclosure is for exemplary explanation and does not have any restrictive meaning for the present disclosure.

Regardless of whether it is called software, firmware, middleware, microcode, hardware description language, or another name, software can be widely construed to refer to a command, a command set, a code, a code segment, a program code, a program, a sub program, a software module, an application, a software application, a software package, a routine, a subroutine, an object, an executable file, an execution thread, a sequence, a function, or the like.

Software, a command, information, and the like may be transmitted and received via a transmission medium. For example, when software is transmitted from a web site, a server, or another remote source using at least one of wired technology (such as a coaxial cable, an optical fiber cable, a twisted-pair wire, or a digital subscriber line (DSL)) and wireless technology (such as infrared rays or microwaves), the at least one of wired technology and wireless technology is included in the definition of the transmission medium.

Information, signals, and the like described in the present disclosure may be expressed using one of various different techniques. For example, data, an instruction, a command, information, a signal, a bit, a symbol, and a chip which can be mentioned in the overall description may be expressed by a voltage, a current, an electromagnetic wave, a magnetic field or magnetic particles, a photo field or photons, or an arbitrary combination thereof.

Terms described in the present disclosure and terms required for understanding the present disclosure may be substituted with terms having the same or similar meanings. For example, at least one of a channel and a symbol may be a signal (signaling). A signal may be a message. A component carrier (CC) may be referred to as a carrier frequency, a cell, a frequency carrier, or the like.

The terms “system” and “network” used in the present disclosure are compatibly used.

Information, parameters, and the like described above in the present disclosure may be expressed as absolute values, may be expressed as values relative to predetermined values, or may be expressed using other corresponding information. For example, radio resources may be indicated by indices.

Names used for the aforementioned parameters are not restrictive in any respect. Mathematical expressions or the like using the parameters may be different from those which are explicitly described in the present disclosure. Since various channels (for example, PUCCH and PDCCH) and information elements can be identified by all appropriate names, various names assigned to the various channels and the information elements are not restrictive in any respect.

The term “determining” or “determination” used in the present disclosure may include various types of operations. The term “determining” or “determination” may include, for example, cases in which judging, calculating, computing, processing, deriving, investigating, looking up, search, or inquiry (for example, looking up in a table, a database, or another data structure), and ascertaining are considered to be “determined.” The term “determining” or “determination” may include cases in which receiving (for example, receiving information), transmitting (for example, transmitting information), input, output, and accessing (for example, accessing data in a memory) are considered to be “determined.” The term “determining” or “determination” may include cases in which resolving, selecting, choosing, establishing, comparing, and the like are considered to be “determined.” That is, the term “determining” or “determination” can include cases in which a certain operation is considered to be “determined.” “Determining” may be replaced with “assuming,” “expecting,” “considering,” or the like.

The terms “connected” and “coupled” or all modifications thereof refer to all direct or indirect connecting or coupling between two or more elements, and can include a case in which one or more intermediate elements are present between the two elements “connected” or “coupled” to each other. Coupling or connecting between elements may be physical, logical, or a combination thereof. For example, “connecting” may be replaced with “access.” In the present disclosure, two elements can be considered to be “connected” or “coupled” to each other using at least one of one or more electrical wires, cables, and printed circuits and using electromagnetic energy or the like having wavelengths of a radio frequency area, a microwave area, and a light (both visible and invisible light) area in some non-limiting and non-inclusive examples.

The expression “based on” used in the present disclosure does not mean “based on only” unless otherwise described. In other words, the expression “based on” means both “based on only” and “based on at least.”

When the terms “include” and “including” and modifications thereof are used in the present disclosure, the terms are intended to have a comprehensive meaning similar to the term “comprising.” The term “or” used in the present disclosure is not intended to mean an exclusive OR operation.

In the present disclosure, for example, when an article such as a, an, or the in English is added in translation, the present disclosure may include a case in which a noun subsequent to the article is of a plural type.

In the present disclosure, the expression “A and B are different” may mean that “A and B are different from each other.” The expression may mean that “A and B are different from C.” Expressions such as “separated” and “coupled” may be construed in the same way as “different.”

### INDUSTRIAL APPLICABILITY

An aspect of the present invention is applied to a demand prediction device that predicts the demand for durable goods, and it is possible to predict a change in demand for each of divisions of durable goods in consideration of selection preferences of each of users.

### REFERENCE SIGNS LIST

100 . . . Demand prediction device, 1001 . . . Processor, 101 . . . Time-series analysis unit, 102 . . . Model generating unit, 103 . . . Purchase probability calculating unit, 104 . . . User extracting unit, 105 . . . Prediction value calculating unit

1: A demand prediction device configured to predict the demand for durable goods, the demand prediction device comprising at least one processor,
wherein the at least one processor is configured to:
calculate time-series data of a prediction value of future demand for durable goods belonging to a particular broad division through time-series analysis based on time-series data of past demand for the durable goods belonging to the particular broad division;
construct a model of machine learning for calculating a purchase probability of the durable goods in each of time periods for each of users and a purchase probability for the broad division and each of a plurality of subdivisions of the durable goods for each of users based on attribute information of users, information on types of durable goods purchased in the past by the users, and time information on the purchase;
calculate purchase probability data including a purchase probability of the durable goods in each of time periods in the future for each of users and a purchase probability for the broad division and each of the plurality of subdivisions of durable goods for each of the users by inputting at least the attribute information of the users to the model; and
calculate and output a prediction value of the total demand for each of the plurality of subdivisions of the durable goods in a particular time period in the future based on the time-series data of the prediction value and the purchase probability data.

2: The demand prediction device according to claim 1, wherein, when a prediction value of the total demand for each of the plurality of subdivisions is calculated, the at least one processor extracts the prediction value of the demand for the durable goods in the particular time period from the time-series data of the prediction value, then extracts a plurality of users corresponding to the number of prediction values of the demand based on the purchase probability of the durable goods in the particular time period based on the purchase probability data for each of users, and calculates the prediction value of the total demand for each of the plurality of subdivisions by totaling the demand for each of subdivisions based on the purchase probability for the broad division and each of the plurality of subdivisions corresponding to the extracted users.

3: The demand prediction device according to claim 2, wherein the at least one processor calculates data of the purchase probability for each of the plurality of subdivisions of a plurality of hierarchies using the model and repeatedly selects the subdivision with the highest purchase probability for each of the plurality of hierarchies for each of the extracted users when the prediction value of the total demand is calculated.

4: The demand prediction device according to claim 2, wherein the at least one processor extracts a user with a relatively high purchase probability for the broad division based on the purchase probability of the durable goods when the plurality of users are extracted.

5: The demand prediction device according to claim 1, wherein the at least one processor calculates and outputs time-series data of the prediction value by repeatedly predicting the total demand for each of the plurality of subdivisions of the durable goods in the particular time period in the future.

6: The demand prediction device according to claim 3, wherein the at least one processor extracts a user with a relatively high purchase probability for the broad division based on the purchase probability of the durable goods when the plurality of users are extracted.

7: The demand prediction device according to any one of claim 2, wherein the at least one processor calculates and outputs time-series data of the prediction value by repeatedly predicting the total demand for each of the plurality of subdivisions of the durable goods in the particular time period in the future.

8: The demand prediction device according to any one of claim 3, wherein the at least one processor calculates and outputs time-series data of the prediction value by repeatedly predicting the total demand for each of the plurality of subdivisions of the durable goods in the particular time period in the future.

9: The demand prediction device according to any one of claim 4, wherein the at least one processor calculates and outputs time-series data of the prediction value by repeatedly predicting the total demand for each of the plurality of subdivisions of the durable goods in the particular time period in the future.

10: The demand prediction device according to any one of claim 6, wherein the at least one processor calculates and outputs time-series data of the prediction value by repeatedly predicting the total demand for each of the plurality of subdivisions of the durable goods in the particular time period in the future.
